(19) United States
(12) Patent Application Publication
(10) Pub. No.: US 2026/0322935 A1
(43) Pub. Date: Oct. 15, 2026

(54) INSPECTION SYSTEM THAT INSPECTS SHEET ON WHICH IMAGE HAS BEEN FORMED

(71) Applicant: CANON KABUSHIKI KAISHA, Tokyo (JP)

(72) Inventor: YUGA YAMAUCHI, Chiba (JP)

(21) Appl. No.: 19/635,419

(22) Filed: Mar. 31, 2026

(30) Foreign Application Priority Data
Apr. 10, 2025 (JP) 2025-065205

(51) Int. Cl. H04N 1/00; G06T 7/00; G06T 7/33; H04N 1/60

(52) U.S. Cl. CPC H04N 1/00819; G06T 7/001; G06T 7/337; H04N 1/00822; H04N 1/605; G06T 2207/10024; G06T 2207/30144; G06T 2207/30168

(57) ABSTRACT

An inspection apparatus includes a reading unit to read conveyed sheets and a reference member, an inspection unit to inspect the sheets, and a calibration unit generating calibration data based on a measurement operation on the reference member. A communication unit receives a time interval between consecutive first and second sheets. A control unit executes the measurement operation between sheet reading operations in a first or second mode. The reading unit starts light emission before the measurement operation in the first mode, but not in the second mode. The control unit selects the first mode if the time interval is equal to or greater than a threshold, and the second mode if shorter.

### BACKGROUND

### Field of the Technology

The present disclosure relates to an inspection system that inspects a sheet on which an image has been formed.

### Description of the Related Art

Conventionally, there has been known an image-forming system including an image-forming apparatus which forms an image on a sheet and an inspection apparatus which is arranged downstream of the image-forming apparatus and inspects the sheet during execution of a job. The inspection performed during execution of a job is also called ‘inline inspection’. In the inline inspection, the inspection apparatus optically reads a sheet on which an image has been formed, analyzes a read image, and determines whether the image on the sheet is appropriate or not. Typically, a defective sheet that has been determined as having a defect is discharged to a discharge destination that is different from a discharge destination of normal sheets.

The optical reading of a sheet in an inspection apparatus is usually performed by irradiating a sheet with light from a light-emitting element and detecting reflected light from the sheet by an image sensor. In such an inspection apparatus, it is common to regularly execute calibration so that non-uniformity of a light amount of the light-emitting element and non-uniformity of sensitivity of the image sensor will not result in degradation in inspection accuracy. The calibration is also called ‘shading correction’. The shading correction is performed by, for example, optically reading reflected light from a white reference member to measure non-uniformity of the light amount or the sensitivity, and correcting read images so as to compensate for an impact of the non-uniformity in accordance with the measurement result. Japanese Patent Application Laid-Open No. 2025-001517 proposes to measure luminance of a reference member to obtain calibration data such as correction coefficients or the like at a timing when a time interval between consecutive sheets temporarily becomes longer so that the operation for calibration during execution of a job over a plurality of sheets will not lower productivity.

However, there has been room in inspection to improve obtainment of the calibration data for calibrating reading operations.

### SUMMARY

Embodiments of the present disclosure provide an inspection apparatus comprising: a conveyance unit configured to convey a sheet on which an image has been formed by an image-forming apparatus; a reading unit configured to execute a reading operation to irradiate the sheet with light and read reflected light from the sheet; an inspection unit configured to inspect the sheet based on a read image generated as a result of the reading operation; a control unit configured to cause the reading unit to execute a measurement operation to irradiate a reference member with light and measure luminance of reflected light from the reference member during a time period when the reading unit does not perform the reading operation; a calibration unit configured to generate calibration data to be used in calibrating the reading operation based on a result of the measurement operation; and a communication unit configured to receive, from the image-forming apparatus, time interval information indicating a time interval between a first sheet and a second sheet conveyed next to the first sheet. The control unit is configured to be able to cause the reading unit to execute the measurement operation in a first measurement mode or a second measurement mode between a first reading operation for the first sheet and a second reading operation for the second sheet. The reading unit is configured to cause a light-emitting element to start light emission before the measurement operation in the first measurement mode. The reading unit is configured not to cause the light-emitting element to emit light before the measurement operation in the second measurement mode. The control unit is configured to cause the reading unit to execute the measurement operation in the first measurement mode in a case where the time interval indicated by the time interval information is equal to or longer than a first threshold, and cause the reading unit to execute the measurement operation in the second measurement mode in a case where the time interval indicated by the time interval information is shorter than the first threshold.

Features of the present disclosure will become apparent from the following description of embodiments with reference to the attached drawings.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a schematic diagram showing an example of a configuration of an image-forming system according to an embodiment.

FIG. 2 is a block diagram showing an example of concrete configurations of control functions of the image-forming system according to an embodiment.

FIG. 3A is a first descriptive diagram for describing an example of image inspection.

FIG. 3B is a second descriptive diagram for describing an example of image inspection.

FIG. 4 is a schematic diagram showing an example of configurations of reading units for measuring luminance of reference members.

FIG. 5 is a graph representing an example of a luminance measurement result.

FIG. 6 is a descriptive diagram for describing an example of correction of a light amount using a gain.

FIG. 7 is a first descriptive diagram for describing an example of correction of read pixel values using correction coefficients.

FIG. 8 is a second descriptive diagram for describing an example of correction of read pixel values using correction coefficients.

FIG. 9 is a descriptive diagram showing how the temperature of a reading unit changes in a job that spans over a plurality of sheets.

FIG. 10 is a descriptive diagram showing how the temperature of the reading unit changes in a case where preliminary light emission is performed in contrast to FIG. 9.

FIG. 11A is a signal chart showing an example of a waveform of an LED drive signal in a measurement operation.

FIG. 11B is a signal chart showing an example of a waveform of an LED drive signal in preliminary light emission.

FIG. 12 is a descriptive diagram for describing pre-adjustment of a sheet interval.

FIG. 13A is a descriptive diagram for measurement control in a first scenario.

FIG. 13B is a descriptive diagram for measurement control in a second scenario.

FIG. 13C is a descriptive diagram for measurement control in a third scenario.

FIG. 14 is a flowchart showing an example of a flow of measurement control processing according to an embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### 1. Overview of System

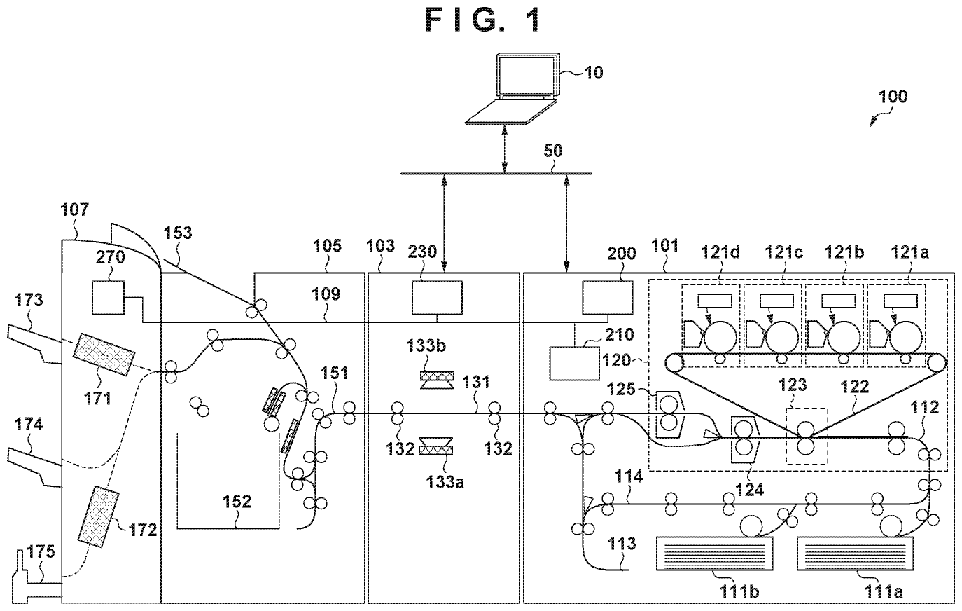

In this section, an overview of a system to which the technology according to the present disclosure may be applied will be described. FIG. 1 is a schematic diagram showing an example of a configuration of an image-forming system 100 according to an embodiment. In addition to the image-forming system 100, a host computer 10 and a communication network 50 are shown in FIG. 1. In the example of FIG. 1, the image-forming system 100 includes an image-forming apparatus 101, an inspection apparatus 103, a stacker 105, and a finisher 107.

### 1-1. Host Computer

The host computer 10 is an information processing apparatus that is communicatively connected to the image-forming system 100 via the communication network 50. The communication network 50 may be any type of network such as a local area network (LAN), the Internet, or a virtual private network (VPN), for example. Although one host computer 10 and one image-forming system 100 are shown in FIG. 1, a plurality of host computers 10 may be connected to one image-forming system 100. In addition, one host computer 10 may be connected to a plurality of image-forming systems 100. The host computer 10 receives a print instruction and input image data from a user, and issues a print job to the image-forming system 100.

### 1-2. Image-forming Apparatus

The image-forming apparatus 101 is an apparatus that receives and executes print jobs. The image-forming apparatus 101 may be a printer or a multifunction peripheral (MFP), for example. In the example of FIG. 1, the image-forming apparatus 101 includes paper feeding units 111a, 111b, an image-forming unit 120, and a conveyance mechanism. Each of the paper feeding units 111a and 111b picks up sheets one by one from a bundle of sheets contained therein to feed them to a conveyance path 112.

The image-forming unit 120 is an image-forming unit that forms an image on a sheet. The image-forming unit 120 includes image-making units 121a, 121b, 121c and 121d, an intermediate transfer belt 122, a secondary transfer unit 123, a first fixing unit 124, and a second fixing unit 125. The image-making units 121a, 121b, 121c and 121d form toner images of color components of yellow (Y), magenta (M), cyan (C), and black (K), respectively. As the image-making units 121a, 121b, 121c and 121d have configurations in common with each other, the image-making unit 121a is taken as an example herein to describe the configuration. The image-making unit 121a forms an electrostatic latent image on a surface of a charged photosensitive drum by exposing the photosensitive drum with light (for example, laser beam) modulated in accordance with input image data. The image-making unit 121a also develops the electrostatic latent image to form a yellow toner image by supplying the electrostatic latent image on the surface of the photosensitive drum with toner. The toner images of respective color components formed by the image-making units 121a, 121b, 121c and 121d are sequentially transferred to the intermediate transfer belt 122 in an overlapping manner (primary transfer), and thereby a full-color toner image is formed. The intermediate transfer belt 122 conveys the full-color toner image to a secondary transfer position in synchronization with a timing at which the sheet arrives at the secondary transfer position of the secondary transfer unit 123. The secondary transfer unit 123 transfers the toner image from the intermediate transfer belt 122 to a first surface of the sheet at the secondary transfer position.

The first fixing unit 124 has a roller (or a belt) heated by a heater, and fixes the toner image to the sheet by melting the toner of the toner image while sandwiching and conveying the sheet. Depending on a type of the sheet, the sheet is conveyed to a path that passes through the second fixing unit 125 when further fixing processing is needed. The second fixing unit 125 has a roller (or a belt) heated by a heater, too, and enhances fixability of the toner image to the sheet by sandwiching and conveying the sheet.

When double-sided printing is designated, the sheet is guided to a reverse conveyance path 113 where its movement direction is reversed and it is conveyed to a double-sided conveyance path 114. Then, it returns to the conveyance path 112 with its front and back surfaces inverted, and the secondary transfer unit 123 transfers a toner image to a second surface of the sheet that has arrived at the secondary transfer position. The sheet that has passed through the first fixing unit 124 (and the second fixing unit 125) with toner image(s) fixed to its single or both side(s) is output from the image-forming apparatus 101 to the inspection apparatus 103.

### 1-3. Inspection Apparatus

The inspection apparatus 103 inspects a sheet on which an image has been formed by the image-forming apparatus 101. In the example of FIG. 1, the inspection apparatus 103 includes a conveyance path 131, a plurality of conveyance rollers 132, a first reading unit 133a, and a second reading unit 133b. The conveyance rollers 132 are conveyance units that convey the sheet accepted from the image-forming apparatus 101 along the conveyance path 131. The first reading unit 133a and the second reading unit 133b are reading units that execute a reading operation. The first reading unit 133a optically reads the first surface of the sheet passing a reading position on the conveyance path 131 to generate a read image of the first surface. The second reading unit 133b optically reads the second surface of the sheet passing a reading position on the conveyance path 131 to generate a read image of the second surface. It should be noted that, in the following descriptions, when there is no need to distinguish the first reading unit 133a and the second reading unit 133b from each other, they are collectively referred to as a reading unit 133. The reading unit 133 may be a contact image sensor (CIS), for example. As described in detail below, the inspection apparatus 103 determines whether or not there is a defect on the sheet on which an image has been formed by the image-forming apparatus 101 based on a read image generated by the reading unit 133. A sheet for which no defect has been detected is treated as a normal sheet, and a sheet for which a defect has been detected is treated as a defective sheet. The normal sheet and the defective sheet are output from the inspection apparatus 103 to the stacker 105.

### 1-4. Stacker

The stacker 105 outputs the sheet inspected by the inspection apparatus 103 to either one of a plurality of trays or to the finisher 107 that is downstream of it. In the example of FIG. 1, the stacker 105 includes a conveyance path 151, a stack tray 152, and an escape tray 153. The stack tray 152 is a large-capacity tray on which normal sheets may be stacked. The escape tray 153 is a tray to which a defective sheet may be discharged. The sheet accepted from the inspection apparatus 103 to the conveyance path 151 is discharged to the stack tray 152, discharged to the escape tray 153, or output to the finisher 107 depending on a result of the inspection for the sheet and whether post-processing is needed or not. The stacker 105 may include a sheet-reversing mechanism for switching between face-down discharge and face-up discharge for a sheet to be discharged to the stack tray 152.

### 1-5. Finisher

The finisher 107 is an apparatus that performs post-processing such as stapling, punching, or bookbinding, for example. In the example of FIG. 1, the finisher 107 includes a first post-processing unit 171, a second post-processing unit 172, and discharge trays 173, 174, and 175. The first post-processing unit 171 provides a stapling function and a punching function, for example. The second post-processing unit 172 provides a saddle stitching bookbinding function, for example. A bundle of sheets for which post-processing designated in the print job has been performed is discharged to the discharge tray 173, 174, or 175. Each of the discharge trays 173, 174, and 175 may have an elevating mechanism.

It should be noted that a configuration of the image-forming system 100 is not limited to the example shown in FIG. 1. For example, the image-forming system 100 does not necessarily include the stacker 105 and, in that case, the finisher 107 is directly coupled downstream of the inspection apparatus 103. In addition, an inserter may be coupled between the image-forming apparatus 101 and the inspection apparatus 103. The inserter inserts an additional sheet between two sheets output from the image-forming apparatus 101.

### 2. Configuration Examples of Control Functions

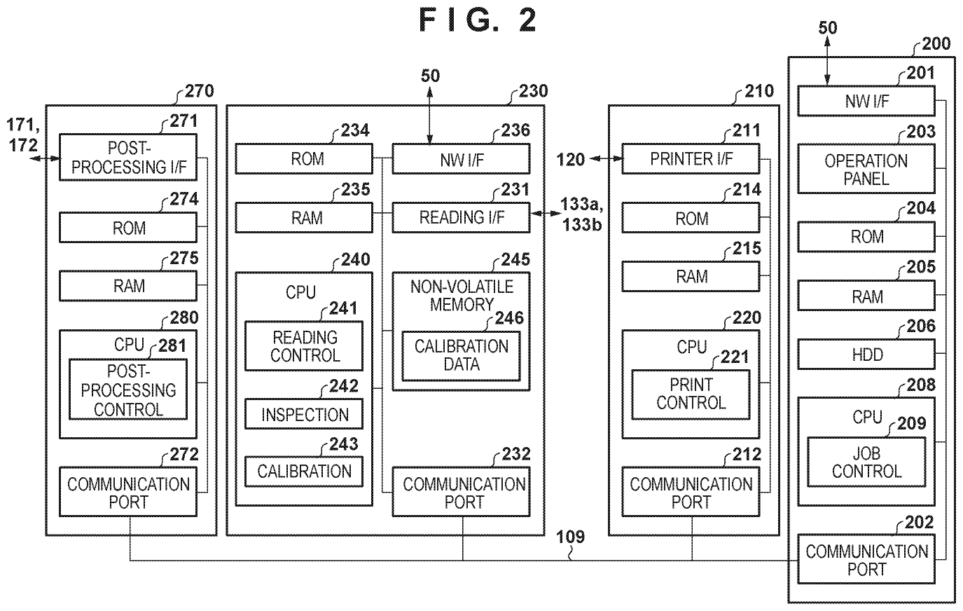

FIG. 1 also shows a main controller 200, a printer controller 210, a scanner controller 230, and a finisher controller 270 that provide control functions of the image-forming system 100. The main controller 200, the printer controller 210, the scanner controller 230, and the finisher controller 270 are mutually connected via a system bus 109. It should be noted that each controller may exist not within the controlled apparatus but within another apparatus that can communicate with the controlled apparatus. FIG. 2 is a block diagram showing an example of concrete configurations of these controllers.

### 2-1. Main Controller

With reference to FIG. 2, the main controller 200 includes a NW I/F 201, a communication port 202, an operation panel 203, a ROM 204, a RAM 205, an HDD 206, and a CPU 208. These constituent elements are mutually connected via an internal bus.

The network (NW) interface (I/F) 201 is an interface for the main controller 200 to communicate with an external apparatus (for example, the host computer 10) via the communication network 50. The communication port 202 is a communication unit for communicating with the printer controller 210, the scanner controller 230, and the finisher controller 270 via the system bus 109. The operation panel 203 is an operation unit that provides a user of the image-forming system 100 with a user interface. The operation panel 203 may be a combination of a display that displays information and an image and input devices that receive user operations and information inputs, for example. The read-only memory (ROM) 204 stores in advance computer programs for the control function of the main controller 200. The random access memory (RAM) 205 provides the CPU 208 with a temporary storage region for computation. The hard disk drive (HDD) 206 is a large-capacity storage device that can store various data such as input image data, read image data, and inspection results. The central processing unit (CPU) 208 functions as a job control unit 209 by executing the computer programs loaded from the ROM 204 to the RAM 205.

Upon receiving a print job from the host computer 10, the job control unit 209 instructs the printer controller 210 to execute the print job. In a case where image inspection is enabled for the print job, the job control unit 209 instructs the scanner controller 230 to inspect a sheet on which an image has been formed by the image-forming apparatus 101. In addition, in a case where certain post-processing is enabled for the print job, the job control unit 209 instructs the finisher controller 270 to apply designated post-processing to a sheet that has passed through the inspection apparatus 103 and the stacker 105.

### 2-2. Printer Controller

The printer controller 210 includes a printer I/F 211, a communication port 212, a ROM 214, a RAM 215, and a CPU 220. These constituent elements are mutually connected via an internal bus.

The printer I/F 211 is an interface for connecting the printer controller 210 to various constituent elements described above of the image-forming unit 120. The communication port 212 is a communication unit for communicating with the main controller 200, the scanner controller 230, and the finisher controller 270 via the system bus 109. The ROM 214 stores in advance computer programs for the control function of the printer controller 210. The RAM 215 provides the CPU 220 with a temporary storage region for computation. The CPU 220 functions as a print control unit 221 by executing the computer programs loaded from the ROM 214 to the RAM 215.

When there is an instruction to execute a print job from the job control unit 209, the print control unit 221 controls the image-forming unit 120 to form an image on a sheet based on input image data. In a case where the print job spans over a plurality of sheets, the sheets are sequentially fed from the paper feeding unit 111a or 111b to the conveyance path 112, and images are formed on respective sheets. In the present specification, descriptions are focused on any consecutive two sheets among a plurality of sequentially-conveyed sheets, one of the two sheets that is conveyed first may be expressed as a first sheet or a preceding sheet, and the other that is subsequently conveyed may be expressed as a second sheet or a subsequent sheet. The second sheet is conveyed next to the first sheet.

The print control unit 221 generates time interval information that indicates a time interval between the first sheet and the second sheet (hereinafter, referred to as a sheet interval) so that the apparatuses located downstream of the image-forming apparatus 101 can process each sheet at an appropriate timing. The time interval information is transmitted to the inspection apparatus 103 via the communication port 212 prior to the second sheet being output from the image-forming apparatus 101 to the inspection apparatus 103. The inspection apparatus 103 forwards the time interval information further to the downstream apparatuses. If an apparatus that received the time interval information foresees that the sheet interval indicated by the time interval information is too short to carry out sheet processing at the apparatus, it requests a delay in outputting a sheet by the print control unit 221. When a downstream apparatus requested the delay in outputting a sheet, the print control unit 221 delays a timing to output the corresponding sheet to the inspection apparatus 103 in accordance with the request. Such pre-adjustment of sheet intervals is performed for all of the pairs of consecutive two sheets among the sheets processed in a print job.

The print control unit 221 can cause the image-forming unit 120 to execute an adjustment operation in the middle of a print job that spans over a plurality of sheets. As an example, the adjustment operation may include ejecting unconsumed deteriorated toner in one or more of the image-making units 121a, 121b, 121c, and 121d. In general, it has been known that, in a case where an image that consumes a small amount of toner (with a low print coverage rate) is formed on a sheet, toner remaining in a developing station without being used for development is accumulated, and deterioration of the accumulated toner might cause degradation in image quality. The ejection of toner as the adjustment operation is performed in order to prevent such accumulation of toner, and may be executed in the middle of a print job depending on the print coverage rate predicted for each sheet. The image-forming unit 120 cannot perform an image-forming operation while the toner ejection is performed.

As another example, the adjustment operation may include correcting positional misalignment between images of different color components (due to temperature rise during an image-forming operation, for example). The correction of positional misalignment may also be referred to as automatic registration correction. The correction of positional misalignment may be performed by forming predetermined reference marks on the intermediate transfer belt 122 by the image-making units 121a, 121b, 121c, and 121d, measuring an amount of misalignment between positions of the formed reference marks, and offsetting an image formation position in accordance with the measured misalignment amount. The image-forming unit 120 cannot perform an image-forming operation while the correction of positional misalignment is performed.

As a further example, the adjustment operation may include correcting color tone of an image of at least one color component. The correction of color tone may be performed by forming predetermined density patterns on the intermediate transfer belt 122 by the image-making units 121a, 121b, 121c, and 121d, measuring the density of the formed density patterns, and changing tone output characteristics in accordance with the measured density. The image-forming unit 120 cannot perform an image-forming operation while the correction of color tone is performed.

In a case where the image-forming unit 120 executes a certain adjustment operation in the middle of a print job, the required time of the adjustment operation is reflected in the above-described time interval information. In other words, the print control unit 221 generates the time interval information for adjustment of an output timing of a sheet based on: whether or not the adjustment operation is executed during a time period from forming an image on the first sheet to forming an image on the second sheet; and a type of the adjustment operation to be executed. For example, the required time is predefined for each type of the adjustment operation, such as 2.5 seconds for ejecting toner, 4.4 seconds for correcting positional misalignment, and 3.4 seconds for correcting color tone. Then, the print control unit 221 can determine a sheet interval for each pair of the first sheet and the second sheet by adding the required time corresponding to the type of the adjustment operation to be executed to a sheet interval of the case with no adjustment operation executed.

### 2-3. Scanner Controller

The scanner controller 230 includes a reading I/F 231, a communication port 232, a ROM 234, a RAM 235, a NW I/F 236, a CPU 240, and a non-volatile memory 245. These constituent elements are mutually connected via an internal bus.

The reading I/F 231 is an interface for connecting the scanner controller 230 to the reading units 133 (the first reading unit 133a and the second reading unit 133b). The communication port 232 is a communication unit for communicating with the main controller 200, the printer controller 210, and the finisher controller 270 via the system bus 109. The ROM 234 stores in advance computer programs for the control function of the scanner controller 230. The RAM 235 provides the CPU 240 with a temporary storage region for computation. The NW I/F 236 is an interface for the scanner controller 230 to communicate with an external apparatus via the communication network 50. The CPU 240 functions as a reading control unit 241, an inspection unit 242, and a calibration unit 243 by executing the computer programs loaded from the ROM 234 to the RAM 235. The non-volatile memory 245 is a storage unit that can store data persistently.

The reading control unit 241 is a control unit for controlling the reading operation of the reading unit 133. When there is an image inspection instruction from the job control unit 209, for example, the reading control unit 241 controls the reading unit 133 to execute the reading operation for a sheet that is conveyed along the conveyance path 131 and passes the reading position. During the reading operation, the reading unit 133 irradiates the sheet with light and reads reflected light from the sheet to generate a read image. The reading control unit 241 determines a timing to cause the reading unit 133 to execute the reading operation in accordance with the above-described time interval information received from the print control unit 221 via the communication port 232.

The inspection unit 242 is an inspection unit that inspects a sheet on which an image has been formed by the image-forming apparatus 101. The inspection unit 242 determines whether or not there is a defect on respective sheets that are subject to the image inspection based on read images generated as a result of the above-described reading operations. The image inspection executed by the inspection unit 242 will be further described below.

The calibration unit 243 is a calibration unit that calibrates the reading operation by the reading unit 133. In the present embodiment, the calibration unit 243 executes calibration processing based on luminance of a reference member measured by the reading unit 133 and generates calibration data 246. The non-volatile memory 245 stores the calibration data 246 generated by the calibration unit 243. In a case where the print job spans over a plurality of sheets, the calibration unit 243 may perform the calibration processing while the print job is being executed, and update the calibration data 246.

In the present embodiment, the calibration unit 243 also functions as a correction unit that executes shading correction. The shading correction is processing of mitigating an impact of non-uniformity of a light amount or sensitivity in a reading operation to enhance accuracy of the image inspection. For example, the calibration unit 243 may correct an amount of light by which the reading unit 133 irradiates a sheet. Alternatively, the calibration unit 243 may correct read pixel values in a read image generated by the reading unit 133. The calibration data 246 indicates one or both of a gain used for correction of the light amount and a correction coefficient used for correction of the read pixel values. The calibration processing and the shading correction executed by the calibration unit 243 will be further described below.

### 2-4. Finisher Controller

The finisher controller 270 includes a post-processing I/F 271, a communication port 272, a ROM 274, a RAM 275, and a CPU 280. These constituent elements are mutually connected via an internal bus.

The post-processing I/F 271 is an interface for connecting the finisher controller 270 to the above-described first post-processing unit 171 and second post-processing unit 172. The communication port 272 is a communication unit for communicating with the main controller 200, the printer controller 210, and the scanner controller 230 via the system bus 109. The ROM 274 stores in advance computer programs for the control function of the finisher controller 270. The RAM 275 provides the CPU 280 with a temporary storage region for computation. The CPU 280 functions as a post-processing control unit 281 by executing the computer programs loaded from the ROM 274 to the RAM 275.

When there is an instruction to execute post-processing in a print job, the post-processing control unit 281 controls the first post-processing unit 171 or the second post-processing unit 172 to apply designated post-processing to sheets that have passed through the inspection apparatus 103 and the stacker 105. In a case where the sheet interval indicated by the above-described time interval information received via the communication port 272 is not sufficient to apply the post-processing to a certain preceding sheet, the post-processing control unit 281 requests a delay in outputting a subsequent sheet by the print control unit 221. Then, the sheet interval between the preceding sheet and the subsequent sheet is extended by the print control unit 221, and a sufficient sheet interval is secured for applying the post-processing.

### 3. Image Inspection

For a print job for which the image inspection is enabled, the inspection unit 242 executes image inspection in accordance with preset inspection items. For example, the inspection unit 242 compares a read image with a correct image that is obtained in advance and determines that there is a defect in the read image in a case where a result of the comparison satisfies a predetermined condition. The correct image may be generated from the input image data by the host computer 10. Alternatively, the correct image may be generated by optically reading a sheet on which the image has been correctly formed.

The inspection unit 242 may also execute variable data inspection. The variable data inspection is an inspection based on matching with variable data that differs on a per-page basis. For the variable data inspection, one or more inspection areas are set in a page for a job that spans over a plurality of pages. The variable data that varies on a per-page basis is associated with each inspection area. Then, the inspection unit 242, for each of the inspection areas, compares the variable data associated with the inspection area with data detected within the inspection area in the read image, and determines whether there is a defect in the sheet based on the comparison result. The data detection within an inspection area may be performed by reading information encoded in a (one-dimensional or two-dimensional) visible code such as a barcode, or may be performed by optical character recognition (OCR), for example.

The inspection unit 242 may also execute front-and-back matching inspection. The front-and-back matching inspection is inspection based on matching between data or an image within an inspection area set on a first surface (front surface) of a sheet and data or an image within an inspection area set on a second surface (back surface) of the sheet. The inspection unit 242, for each pair of inspection areas of the first surface and the second surface, compares data or images detected within the inspection areas, and determines that there is a defect in the sheet in a case where a mismatch is found between them.

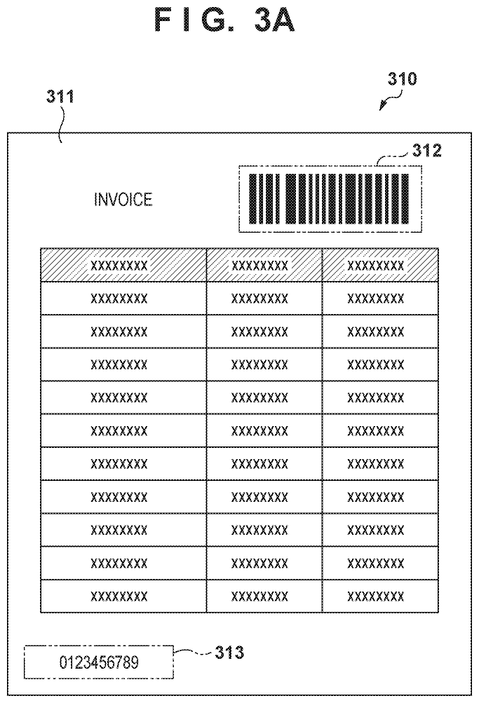

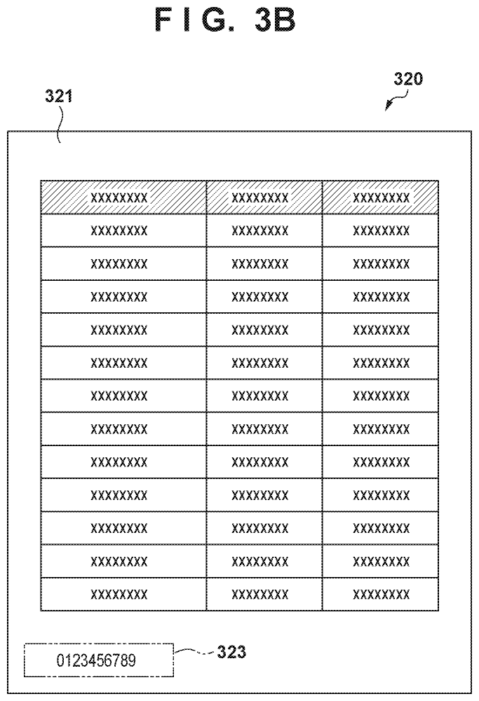

FIG. 3A and FIG. 3B are descriptive diagrams for describing an example of the image inspection executed by the inspection unit 242. FIG. 3A shows a read image 310 of a first surface of a sheet, and FIG. 3B shows a read image 320 of a second surface of the same sheet. The read image 310 includes an image region 311 in which an image is formed based on input image data. Inspection areas 312 and 313 are set in the read image 310. The inspection area 312 is an area for which variable data inspection targeting a one-dimensional barcode is performed. The inspection area 313 is an area for which front-and-back matching inspection based on reading of numerical values is performed. The read image 320 includes an image region 321 in which an image is formed based on input image data. An inspection area 323 is set in the read image 320. The inspection area 323 is an area for which front-and-back matching inspection based on reading of numerical values is performed, and corresponds to the inspection area 313 of the read image 310.

For example, the inspection unit 242 determines that there is a defect in the sheet in a case where the image region 311 of the read image 310 or the image region 321 of the read image 320 includes a part that is different from the correct image. The inspection unit 242 also determines that there is a defect in the sheet in a case where data obtained by decoding the barcode in the inspection area 312 of the read image 310 does not match variable data associated with the inspection area 312 (or in a case where the barcode is not decodable). The inspection unit 242 also determines that there is a defect in the sheet in a case where a numerical value read in the inspection area 313 of the read image 310 does not match a numerical value read in the inspection area 323 of the read image 320. In a case where no defect is detected in any inspection, the inspection unit 242 determines that the sheet is normal.

It should be noted that the image inspection executed by the inspection unit 242 is not limited to the examples described above. For example, the inspection unit 242 may execute inspection on inspection items such as misalignment of an image formation position, page duplication, page skipping, a streaky or dot-like stain in the sheet, or color tone deviation. As there are publicly known methods to perform inspection on such inspection items, descriptions thereof are omitted here. The inspection-related settings such as the inspection items, the inspection areas, and the variable data may be received on a setting screen displayed by a display of the inspection apparatus 103 or another apparatus (for example, the host computer 10) that can communicate with the inspection apparatus 103.

### 4. Calibration Processing and Shading Correction

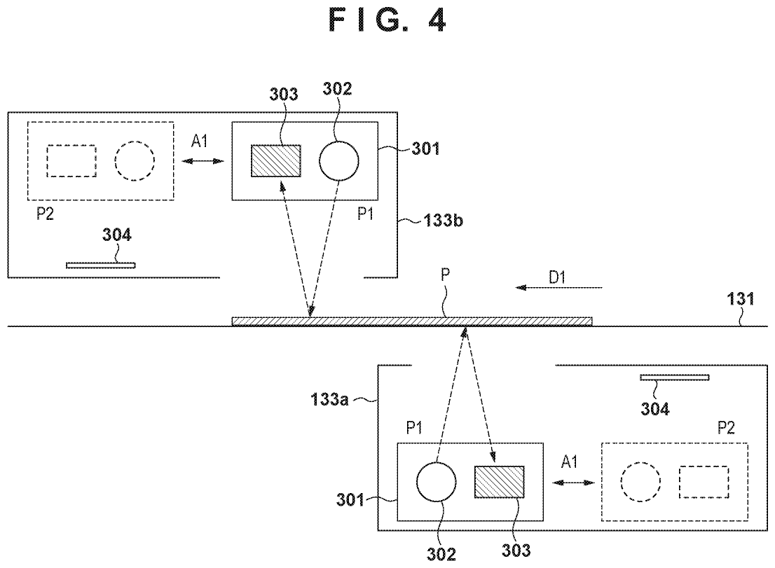

The calibration processing executed by the calibration unit 243 is based on a result of luminance measurement on a reference member by the reading unit 133. FIG. 4 shows an example of configurations of the reading units 133 for measuring luminance of reference members. With reference to FIG. 4, the first reading unit 133a is disposed below the conveyance path 131, and the second reading unit 133b is disposed above the conveyance path 131. As the configuration of the second reading unit 133b may be similar to the configuration of the first reading unit 133a except that it is upside down, only the configuration of the first reading unit 133a will be described here.

The first reading unit 133a includes: a CIS unit 301 that includes a light-emitting diode (LED) 302 and a reading sensor 303; and a reference white plate 304. The CIS unit 301 is driven by a motor (not shown) so that it can move between a reading position P1 and a measurement position P2 in the horizontal direction Al in the figure.

At the time of executing the reading operation, the CIS unit 301 is located at the reading position P1. When a sheet P is conveyed along the conveyance path 131 in a sub-scanning direction D1 and passes a position facing the CIS unit 301, the LED 302 irradiates the sheet P with light. The sheet P reflects the irradiation light. The reading sensor 303 reads the reflected light from the sheet P (see broken lines in the figure). The CIS unit 301 generates a read image based on a result of reading over the sheet width (in a main scanning direction that is perpendicular to the sub-scanning direction D1) and the sheet length (in the sub-scanning direction D1), and outputs the generated read image to the CPU 240.

The measurement operation for the calibration processing is executed during a time period when the CIS unit 301 does not perform the reading operation. For the measurement operation, the CIS unit 301 moves to the measurement position P2. The reference white plate 304 is disposed such that it faces the CIS unit 301 located at the measurement position P2. During the measurement operation, the LED 302 irradiates the reference white plate 304 with light. The reference white plate 304 reflects the irradiation light. The reading sensor 303 measures luminance of the reflected light from the reference white plate 304. The CIS unit 301 outputs, to the CPU 240, a result of luminance measurement over the sheet width in the main scanning direction.

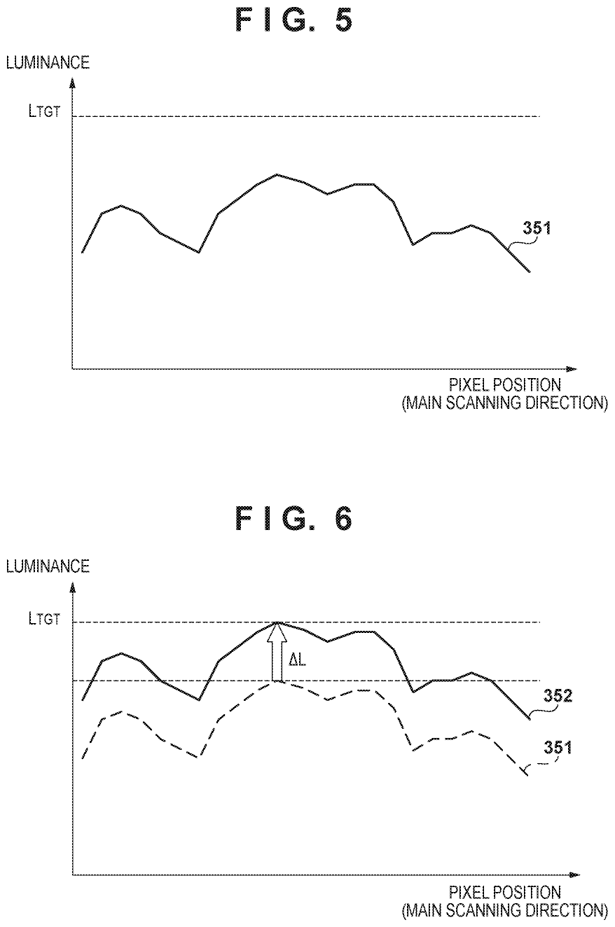

FIG. 5 shows a graph 351 representing an example of a luminance measurement result. The horizontal axis of the graph 351 represents pixel positions in the main scanning direction, and the vertical axis of the graph 351 represents measured luminance values. A target luminance L_{TGT} is a measured value of luminance of an ideal white light that does not depend on pixel positions. As seen from FIG. 5, the graph 351 deviates from the target luminance L_{TGT} at most pixel positions and is not uniform across pixel positions due to non-uniformity of the light amount of the LED 302 and non-uniformity of the sensitivity per pixel position of the reading sensor 303.

FIG. 6 is a descriptive diagram for describing an example of correction of a light amount using a gain. In FIG. 6, the luminance measurement result before applying light amount correction is indicated by a broken-line graph 351, and a luminance measurement result after applying light amount correction is indicated by a solid-line graph 352. The calibration unit 243 calculates a gain ΔL such that the maximum value of luminance measured during the measurement operation coincides or at least comes close to the target luminance L_{TGT}, for example. The gain ΔL is a control parameter by which an output level of a light amount of the LED 302 is multiplied. In the example of FIG. 6, as indicated by the graph 352, the light amount of the LED 302 is amplified using the gain ΔL, and the luminance measurement result has come close to the target luminance L_{TGT} at every pixel position. It should be noted that the value of the target luminance L_{TGT} may be preset in a fixed manner, or may be variably set for each print job.

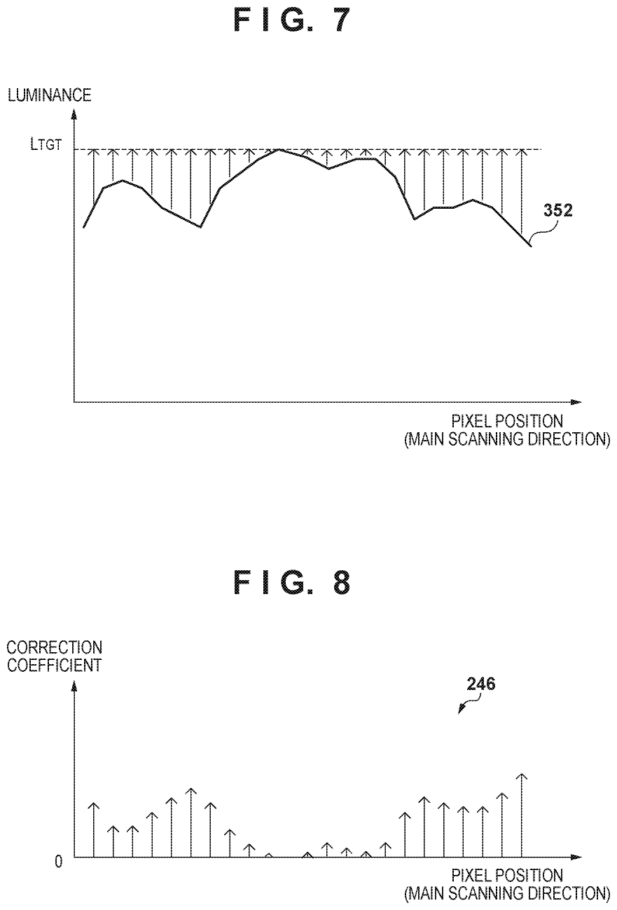

FIG. 7 and FIG. 8 are descriptive diagrams for describing an example of correction of read pixel values using correction coefficients. FIG. 7 shows, conceptually by an arrow, a magnitude of a correction coefficient for each pixel position in the main scanning direction calculated by the calibration unit 243 in addition to the graph 352 and the target luminance L_{TGT}. The calibration unit 243 calculates, for each pixel position, the correction coefficient such that the luminance measurement result coincides with the target luminance L_{TGT}. In FIG. 8, while the horizontal axis represents pixel positions in the main scanning direction as in the case of FIG. 7, the vertical axis represents magnitudes of the correction coefficients. In the example of FIG. 8, the correction coefficient indicates zero at the pixel position at which the luminance measurement result is the closest to the target luminance L_{TGT} in the graph 351, and the correction coefficient indicates a larger value at a pixel position at which a deviation from the target luminance L_{TGT} is larger. The correction coefficients are used in multiplying read pixel values at respective pixel positions of read images generated by the reading unit 133 in reading operations. In this manner, an impact on read images from non-uniformity of the light amount or the sensitivity is mitigated, and the image inspection accuracy is enhanced.

The calibration data 246 generated by the calibration unit 243 in the calibration processing indicates the gain and the correction coefficients determined in this manner. It should be noted that correction of the light amount using the gain may not be performed in the shading correction. In that case, a component corresponding to the gain ΔL shown in FIG. 6 is reflected in the correction coefficients at respective pixel positions.

### 5. Re-Execution of Measurement Operation and Calibration Processing During Job

When the image inspection is repeated for a large number of sheets in a print job, temperature of the reading unit 133 rises due to heat generated by the LED 302 of the reading unit 133. The temperature rise continues until an amount of heat generation of the LED 302 is balanced with an amount of heat absorption due to an airflow in the apparatus and a temperature difference from the ambient temperature outside the apparatus, and finally stops upon reaching a certain temperature. The temperature change during execution of a print job affects reading characteristics of the reading unit 133, and degrades inspection accuracy of the inline inspection. For example, as the calibration data 246 that has been once determined will not accurately reflect the characteristics of the LED 302 and the reading sensor 303 after the temperature rise, the effect of the shading correction based on the same calibration data 246 will degrade.

Hence, in the present embodiment, the reading control unit 241 causes the reading unit 133 to re-execute the measurement operation in the middle of a print job that spans over a plurality of sheets. Specifically, the reading control unit 241 is configured to be able to cause the reading unit 133 to execute the measurement operation between a first reading operation for the first sheet and a second reading operation for the second sheet. When the measurement operation is re-executed, the calibration unit 243 updates the calibration data 246 based on a luminance measurement result.

The re-execution of the measurement operation does not need to be performed until the image inspection is repeated for at least a certain number of sheets after the previous measurement operation. Hence, the reading control unit 241 counts, as the number of read sheets Cₛₕ, the number of sheets for which the reading operation is performed after the reading unit 133 previously executed the measurement operation. Then, the reading control unit 241 does not cause the reading unit 133 to re-execute the measurement operation in a case where the number of read sheets Cₛₕ does not reach a predetermined lower limit number of sheets Cₘᵢₙ. In this manner, excessively frequent re-execution of the measurement operation is avoided. When the number of read sheets Cₛₕ reaches the lower limit number of sheets Cₘᵢₙ, there is a possibility that the reading characteristics of the reading unit 133 have significantly changed. Therefore, the reading control unit 241 causes the reading unit 133 to re-execute the measurement operation in a case where a condition described below is satisfied.

As understood from the above descriptions, the measurement operation requires a certain amount of time because it includes a physical movement of the CIS unit 301 going back and forth between the reading position P1 and the measurement position P2. For example, the required time of the measurement operation is 2.4 seconds. This required time is longer than a normal sheet interval of sheets that the inspection apparatus 103 accepts from the image-forming apparatus 101. Hence, in the present embodiment, the reading control unit 241 determines whether or not to re-execute the measurement operation based on a sheet interval Iₛₕ indicated by the time interval information received from the image-forming apparatus 101 so that re-execution of the measurement operation will not degrade productivity of a print job. Specifically, the reading control unit 241 causes the reading unit 133 to re-execute the measurement operation in a case where the sheet interval Iₛₕ is equal to or longer than a predetermined time threshold Iₜₕ₂, and does not cause the reading unit 133 to re-execute the measurement operation in a case where the sheet interval Iₛₕ is shorter than the time threshold Iₜₕ₂. The time threshold Iₜₕ₂ herein is set to be longer than the time required for the CIS unit 301 to go back and forth between the reading position P1 and the measurement position P2.

For example, in a case where the adjustment operation such as toner ejection, positional misalignment correction, or color tone correction described above is executed in the image-forming apparatus 101, the sheet interval between the preceding sheet and the subsequent sheet at the time of the execution becomes longer than a normal interval. Thus, the reading control unit 241 can cause the reading unit 133 to re-execute the measurement operation at the timing when the sheet interval temporarily increases because of the execution of the adjustment operation.

### 6. Preliminary Light Emission Before Re-Execution of Measurement Operation

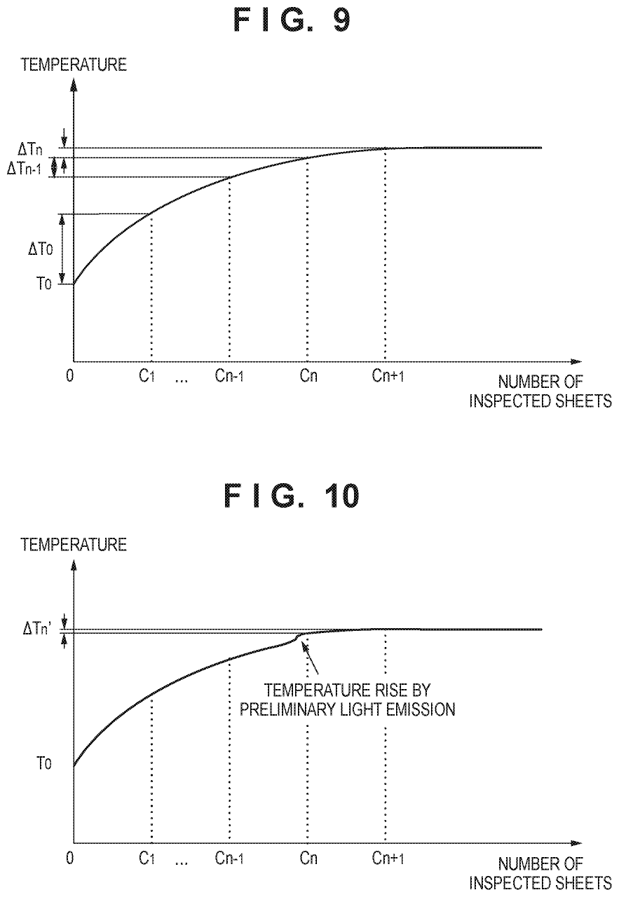

FIG. 9 is a descriptive diagram showing how temperature of the reading unit 133 changes in a job that spans over a plurality of sheets. The horizontal axis of FIG. 9 represents a number of sheets for which the image inspection has been performed in the same job, and the vertical axis represents the temperature of the reading unit 133. Cₙ represents a timing of n-th re-execution of the measurement operation (n=1, 2, 3, . . . ). In the illustrated example, the temperature is T₀ at the time point when the job starts, and rises by ΔT₀ until the time point of the first measurement operation. The amount of rise in the temperature gradually gets smaller over time, and will be ΔTₙ₋₁ between the Cₙ₋₁-th measurement operation and the Cₙ-th measurement operation, and ΔTₙ between the Cₙ-th measurement operation and the Cₙ₊₁-th measurement operation, where ΔT₀>ΔTₙ₋₁>ΔTₙ.

As understood from FIG. 9, the higher the temperature of the reading unit 133 at the timing of re-executing the measurement operation is, the smaller the amount of rise in the temperature of the reading unit 133 until the next re-execution is. If the amount of rise in the temperature is small, an amount of change in the reading characteristics of the reading unit 133 during the corresponding time period will be small, resulting in suppressed degradation of the image inspection accuracy. Hence, in the present embodiment, the reading control unit 241 is configured to be able to cause the reading unit 133 to re-execute the measurement operation in either one of a first measurement mode or second measurement mode.

When the reading control unit 241 selects the first measurement mode, the reading unit 133 causes the LED 302 to start light emission preliminarily before executing the measurement operation. In the present specification, this light emission of the LED 302 before the measurement operation is referred to as preliminary light emission. The temperature of the reading unit 133 at the time of re-executing the measurement operation can be raised by the heat that is generated by the LED 302 while the preliminary light emission is performed. On the other hand, when the reading control unit 241 selects the second measurement mode, the reading unit 133 does not cause the LED 302 to perform the preliminary light emission before executing the measurement operation.

FIG. 10 is a descriptive diagram showing how temperature of the reading unit 133 changes in a case where the preliminary light emission is performed in contrast to FIG. 9. In the example of FIG. 10, n-th re-execution of the measurement operation takes place at the timing when the number of sheets for which the image inspection has been performed reaches Cₙ. In addition, prior to the n-th re-execution, the reading unit 133 forces the LED 302 to emit light so as to raise the temperature of the reading unit 133 in advance. As a result, while the amount of rise in the temperature between the Cₙ-th measurement operation and the Cₙ₊₁-th measurement operation is ΔTₙ in the example of FIG. 9, the amount of rise in the temperature during the same time period in the example of FIG. 10 is ΔTₙ′, and the amount of rise in the temperature in the latter case in which the preliminary light emission is performed is smaller (ΔTₙ>ΔTₙ′). In this manner, the effect of the shading correction is maintained for a sufficient time length, and degradation of the image inspection accuracy is suppressed.

Although the amount of rise in the temperature by the preliminary light emission is larger as the duration of the preliminary light emission is longer, if the preliminary light emission is performed when the sheet interval does not include a sufficient margin, productivity of a print job would actually degrade. Hence, in the present embodiment, the reading control unit 241 is configured to select the first measurement mode in a case where the sheet interval Iₛₕ is equal to or longer than a predetermined time threshold Iₜₕ₁, and cause the reading unit 133 to execute the measurement operation in the first measurement mode including the preliminary light emission. The time threshold Iₜₕ₁ herein is set to a value that is at least greater than the time threshold Iₜₕ₂ described above (Iₜₕ₁>Iₜₕ₂). For example, in a case where Iₜₕ₂ is equal to 2.4 seconds, Iₜₕ₁ may be equal to 3.4 seconds. In a case where the sheet interval Iₛₕ is shorter than the time threshold Iₜₕ₁, the reading control unit 241 selects the second measurement mode, and causes the reading unit 133 to start the measurement operation soon without performing the preliminary light emission.

In the first measurement mode, the reading unit 133 may cause the LED 302 to start the preliminary light emission at a second light amount level that is greater than a first light amount level set in the measurement operation. While the first light amount level set in the measurement operation is constrained to be a light amount that is suitable for the calibration processing, there is no such constraint with the preliminary light emission. Therefore, by setting the second light amount level in the preliminary light emission to be a greater value than the first light amount level, it is possible to raise the temperature of the reading unit 133 efficiently by the preliminary light emission for a short duration.

In a certain embodiment example, the reading unit 133 includes a switching element disposed between a power supply circuit and the LED 302. The reading control unit 241 controls the light amount of the LED 302 through pulse width modulation (PWM) by varying a pulse width of an LED drive signal that is a pulse signal for opening and closing the switching element. In this embodiment example, a light amount difference between the first light amount level and the second light amount level is based on a difference in a duty ratio in PWM. The reading control unit 241 may set the duty ratio of PWM to 100% when it causes the LED 302 to emit light at the second light amount level in the preliminary light emission. In this manner, it is possible to maximize efficiency of the temperature rise of the reading unit 133 in the preliminary light emission.

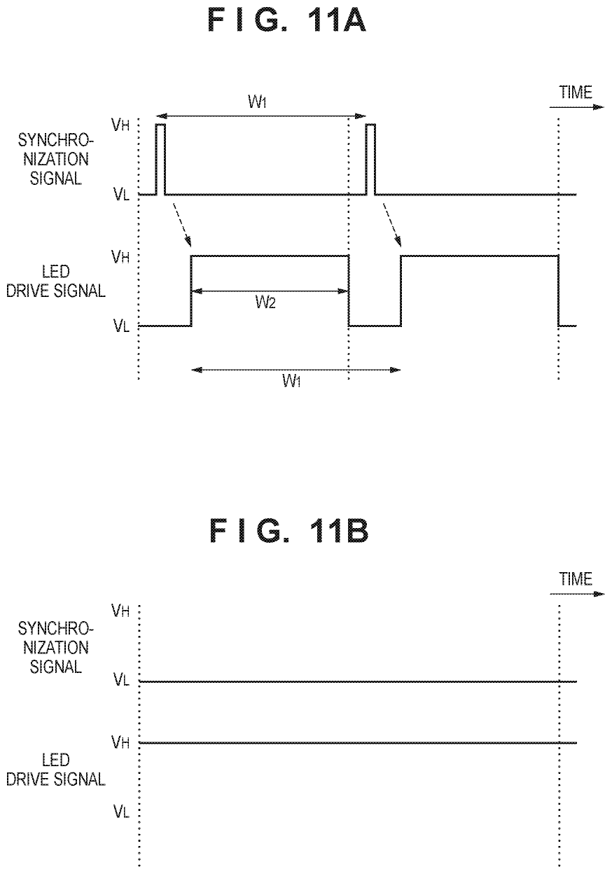

FIG. 11A shows an example of a waveform of the LED drive signal in the measurement operation together with a waveform of a synchronization signal that determines a duty cycle. The synchronization signal herein indicates a measurement cycle for one line in the main scanning direction by rising of a pulse from a low level V_{L} to a high level V_{H}. The measurement cycle may be the same as a reading cycle for each line in the main scanning direction in the reading operation. The LED drive signal instructs light emission from the LED 302 by indicating the high level V_{H}, and instructs non-light-emission from the LED 302 by indicating the low level V_{L}. In the example of FIG. 11A, a ratio of a time length W₂ for which the LED drive signal instructs light emission from the LED 302 to a time length W₁ of the duty cycle that corresponds to the reading cycle indicated by the synchronization signal, that is, the duty ratio is W₂/W₁=75%. This corresponds to the first light amount level in the measurement operation. It should be noted that the first light amount level for an actual measurement operation may be arbitrarily adjusted through an experiment before shipment of an apparatus.

FIG. 11B shows an example of a waveform of the LED drive signal in the preliminary light emission. In the example of FIG. 11B, the LED drive signal is fixed to the high level V_{H}, and the duty ratio of PWM is 100%. This corresponds to the second light amount level in the preliminary light emission. During the time period of the preliminary light emission, the synchronization signal does not need to be provided because no measurement operation is performed. It should be noted that the duty ratio corresponding to the second light amount level is not necessarily 100%, and may be any duty ratio that is higher than a duty ratio corresponding to the first light amount level.

In another embodiment example, the reading unit 133 includes a variable voltage circuit for allowing an amount of current supplied to the LED 302 to be adjusted. The reading control unit 241 controls the light amount of the LED 302 by varying voltage applied to the LED 302 to adjust the amount of current supplied to the LED 302. In this embodiment example, the light amount difference between the first light amount level and the second light amount level is based on a difference in the amount of current that flows through the LED 302. When causing the LED 302 to emit light at the second light amount level in the preliminary light emission, the reading control unit 241 may apply the maximum allowed voltage to the LED 302 to maximize efficiency of the temperature rise of the reading unit 133 in the preliminary light emission.

### 7. Pre-Adjustment of Sheet Interval

As described above, when executing a print job that spans over a plurality of sheets, prior to conveyance of each sheet, the image-forming apparatus 101, the inspection apparatus 103, and the finisher 107 perform pre-adjustment for adjusting a sheet interval between the sheet and an immediately preceding sheet. For the pre-adjustment, the print control unit 221 of the image-forming apparatus 101 functions as a generation unit that generates timing information including the above-described time interval information.

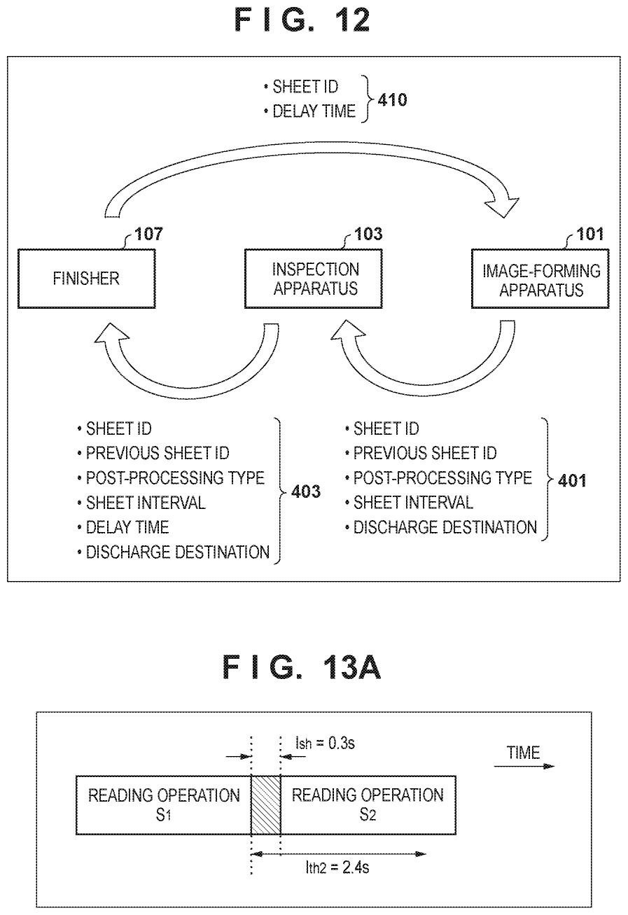

FIG. 12 is a descriptive diagram for describing pre-adjustment of a sheet interval. For example, the print control unit 221 determines, for an i-th conveyed sheet Sᵢ (i is an integer that is equal to or greater than 2), whether or not a certain adjustment operation is executed during an interval from forming an image on a sheet Sᵢ₋₁ to forming an image on the sheet Sᵢ. In a case where no adjustment operation is executed, the print control unit 221 sets the sheet interval Iₛₕ for the sheet Sᵢ to a predetermined normal time interval Tₛ as in the following expression (1).

Iₛₕ=Tₛ (1)

In a case where an adjustment operation is executed, the print control unit 221 sets the sheet interval Iₛₕ for the sheet Sᵢ to a sum of the predetermined normal time interval Tₛ and required time T_{A} of the adjustment operation to be executed, as in the following expression (2).

Iₛₕ=Tₛ+T_{A} (2)

It should be noted that the required time T_{A} of the adjustment operation may differ depending on a type of the adjustment operation to be executed.

The print control unit 221 generates timing information 401 for the sheet Sᵢ. As shown in FIG. 12, the timing information 401 may include the following information items, for example:

‘SHEET ID’
‘PREVIOUS SHEET ID’
‘POST-PROCESSING TYPE’
‘SHEET INTERVAL’
‘DISCHARGE DESTINATION’

‘SHEET ID’ is an identifier (for example, the above-described index i) identifying a sheet that is subject to the timing information 401 (also referred to as a sheet of interest). ‘PREVIOUS SHEET ID’ is an identifier identifying a preceding sheet that is conveyed immediately before the sheet of interest. ‘POST-PROCESSING TYPE’ is information designating a type of post-processing to be applied to the sheet of interest. ‘SHEET INTERVAL’ is time interval information indicating a sheet interval that is set by the expression (1) or the expression (2) for the sheet of interest. ‘DISCHARGE DESTINATION’ is information designating a tray to which the sheet of interest should be discharged. The print control unit 221 transmits the timing information 401 to the inspection apparatus 103.

The reading control unit 241 of the inspection apparatus 103 receives the timing information 401 via the communication port 232. Typically, the timing information 401 for the i-th sheet of interest Sᵢ is received prior to the sheet of interest Sᵢ being output from the image-forming apparatus 101 to the inspection apparatus 103 (for example, it is received earlier by a time interval corresponding to three sheets). Upon receiving the timing information 401, the reading control unit 241 determines whether or not the number of read sheets Cₛₕ reaches a predetermined upper limit number of sheets Cₘₐₓ for the sheet of interest Sᵢ. In a case where the number of read sheets Cₛₕ reaches the predetermined upper limit number of sheets Cₘₐₓ, the reading control unit 241 determines whether the sheet interval Iₛₕ indicated by the time interval information for the sheet of interest Sᵢ has a time length sufficient for the measurement operation. For example, in a case where the sheet interval Iₛₕ is equal to or longer than the above-described time threshold Iₜₕ₂, the sheet interval Iₛₕ has a time length sufficient for the measurement operation, and thus there is no need to adjust the sheet interval Iₛₕ at least for the purpose of the measurement operation. On the other hand, in a case where the sheet interval Iₛₕ is shorter than the time threshold Iₜₕ₂, the sheet interval Iₛₕ does not have a time length sufficient for the measurement operation. Therefore, in this case, the reading control unit 241 determines a delay time dₛₕ for delaying the output of the sheet of interest Sᵢ from the image-forming apparatus 101 such that the sheet interval Iₛₕ becomes at least no shorter than the time threshold Iₜₕ₂ (Iₛₕ+dₛₕ≥ Iₜₕ₂). For example, the delay time dₛₕ may be equal to the difference resulting from subtracting the tentative sheet interval Iₛₕ from the time threshold Iₜₕ₂ (dₛₕ=Iₜₕ₂-Iₛₕ).

The reading control unit 241 generates timing information 403 by adding the delay time dₛₕ determined for the sheet Sᵢ to the timing information 401. As shown in FIG. 12, the timing information 403 may include the following information items, for example:

‘SHEET ID’
‘PREVIOUS SHEET ID’
‘POST-PROCESSING TYPE’
‘SHEET INTERVAL’
‘DELAY TIME’
‘DISCHARGE DESTINATION’

Values of the information items other than ‘DELAY TIME’ may be the same as those in the timing information 401. A value of ‘DELAY TIME’ indicates the above-described dₛₕ. The reading control unit 241 transmits the timing information 403 via the stacker 105 located downstream of it to the finisher 107.

The post-processing control unit 281 of the finisher 107 receives the timing information 403 via the communication port 272. Upon receiving the timing information 403, the post-processing control unit 281 determines whether the sum of the sheet interval Iₛₕ and the delay time dₛₕ is sufficient for executing the post-processing designated to be applied to the sheet of interest Sᵢ. In a case where there is sufficient time secured for executing the post-processing, the post-processing control unit 281 determines that no further adjustment to the sheet interval Iₛₕ is needed. On the other hand, in a case where sufficient time for executing the post-processing has not been secured, the post-processing control unit 281 updates the delay time dₛₕ such that the sum of the sheet interval Iₛₕ and the delay time dₛₕ becomes at least no shorter than the required time of the post-processing. Then, the post-processing control unit 281 transmits feedback information 410 that may include the following information items back to the print control unit 221 of the image-forming apparatus 101:

‘SHEET ID’
‘DELAY TIME’

In a case where no further adjustment to the sheet interval Iₛₕ is needed for the post-processing, ‘DELAY TIME’ indicates the same value as the delay time notified from the inspection apparatus 103. In a case where further adjustment to the sheet interval Iₛₕ is needed for the post-processing, ‘DELAY TIME’ indicates a value updated by the post-processing control unit 281.

Upon receiving the feedback information 410 from the post-processing control unit 281, the print control unit 221 updates the sheet interval Iₛₕ for the sheet of interest Sᵢ by adding the value of ‘DELAY TIME’ included in the feedback information 410 (Iₛₕ+dₛₕ→Iₛₕ). The updated value of the sheet interval Iₛₕ is notified again to the reading control unit 241 of the inspection apparatus 103 as a part of the timing information 401.

In a case where the number of read sheets Cₛₕ reaches the upper limit number of sheets Cₘₐₓ, the reading control unit 241 can cause the reading unit 133 to re-execute the measurement operation during the sheet interval between the preceding sheet and the sheet of interest that is secured through such pre-adjustment. On the other hand, in a case where the number of read sheets Cₛₕ does not reach the upper limit number of sheets Cₘₐₓ, the reading control unit 241 determines whether re-execution of the measurement operation is needed or not as well as a measurement mode based on comparing the sheet interval Iₛₕ indicated by the time interval information with the above-described time thresholds Iₜₕ₁ and Iₜₕ₂.

### 8. Some Examples of Scenarios of Measurement Control

Assume that the above-described parameters for measurement control are set to the following values, for example:
Lower Limit Number of Sheets Cₘᵢₙ=20 [sheets]
Upper Limit Number of Sheets Cₘₐₓ=200 [sheets]
First Threshold Iₜₕ₁=3.4 [seconds]
Second Threshold Iₜₕ₂=2.4 [seconds]

Then, conditional branching of the measurement control based on the number of read sheets Cₛₕ and the sheet interval Iₛₕ can be summarized, for example, as follows:

```
  • If Cₛₕ < 20 then
    i) the measurement operation is not re-executed
  • If 20 ≤ Cₛₕ < 200 then
    ii) Iₛₕ < 2.4 then
      → the measurement operation is not re-executed
    iii) 2.4 ≤ Iₛₕ < 3.4 then
      → the measurement operation is re-executed in the second
measurement mode (without preliminary light emission)
    iv) 3.4 ≤ Iₛₕ then
      → the measurement operation is re-executed in the first
measurement mode (with preliminary light emission)
  • If 200 ≤ Cₛₕ then
    v) 2.4 ≤ Iₛₕ < 3.4 then
      → the measurement operation is re-executed in the second
measurement mode (without preliminary light emission)
    vi) 3.4 ≤ Iₛₕ then
      → the measurement operation is re-executed in the first
measurement mode (with preliminary light emission)
```

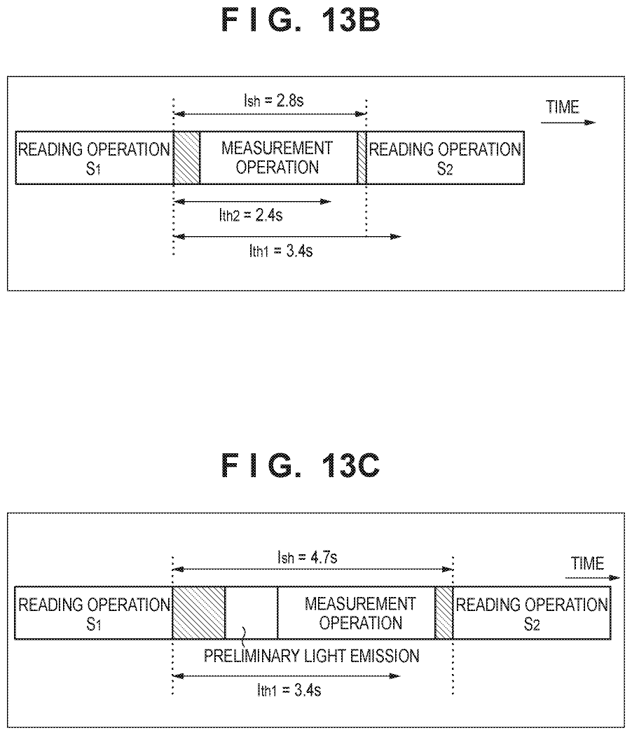

FIGS. 13A to 13C are descriptive diagrams for measurement control in three different scenarios. These scenarios assume in common that the normal sheet interval is 0.3 seconds and the number of read sheets Cₛₕ satisfies 20≤Cₛₕ<200.

In the first scenario of FIG. 13A, in the image-forming apparatus 101, no adjustment operation is executed between the first sheet S₁ and the second sheet S₂. The sheet interval Iₛₕ determined for the second sheet S₂ is: Iₛₕ=Tₛ=0.3 seconds. Thus, the first scenario corresponds to the above condition ii. In this case, as illustrated in FIG. 13A, the measurement operation is not re-executed between the reading operation for the first sheet S₁ and the reading operation for the second sheet S₂. It should be noted that shading in the figure represents a standby state of the reading unit 133.

In the second scenario of FIG. 13B, in the image-forming apparatus 101, toner ejection that requires T_{A}=2.5 seconds is executed between the first sheet Sᵢ and the second sheet S₂. The sheet interval Iₛₕ determined for the second sheet S₂ is: Iₛₕ=2.8 (=0.3+2.5) seconds. Thus, the second scenario corresponds to the above condition iii. In this case, as illustrated in FIG. 13B, the measurement operation is re-executed in the second measurement mode without preliminary light emission between the reading operation for the first sheet S₁ and the reading operation for the second sheet S₂.

In the third scenario of FIG. 13C, in the image-forming apparatus 101, positional misalignment correction that requires T_{A}=4.4 seconds is executed between the first sheet S₁ and the second sheet S₂. The sheet interval Iₛₕ determined for the second sheet S₂ is: Iₛₕ=4.7 (=0.3+4.4) seconds. Thus, the third scenario corresponds to the above condition iv. In this case, as illustrated in FIG. 13C, the measurement operation is re-executed in the first measurement mode with preliminary light emission between the reading operation for the first sheet S₁ and the reading operation for the second sheet S₂.

### 9. Flow of Measurement Control Processing

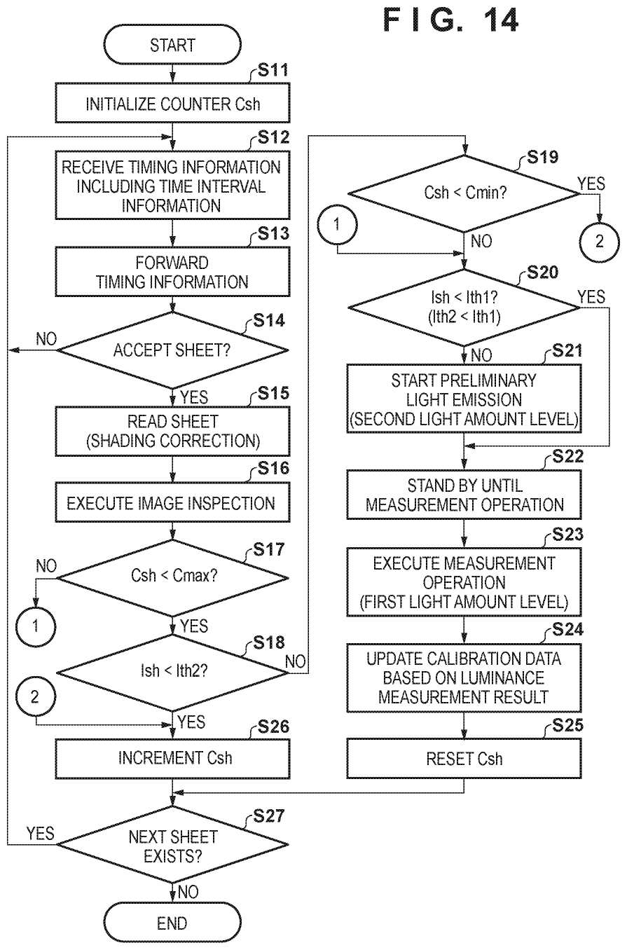

FIG. 14 is a flowchart showing an example of a flow of measurement control processing according to the above-described embodiment. The measurement control processing of FIG. 14 is executed by the CPU 240 of the inspection apparatus 103 in response to the image-forming system 100 receiving a print job for which the image inspection is enabled. In the following descriptions, ‘S’ is an abbreviation of a processing step.

First, in S11, the reading control unit 241 initializes a counter Cₛₕ of the number of sheets to zero. The reading control unit 241 also activates the reading unit 133.

Next, in S12, the reading control unit 241 receives, from the print control unit 221 of the image-forming apparatus 101, timing information including time interval information for a sheet that the image-forming apparatus 101 will output. Next, in S13, the reading control unit 241 forwards the timing information to the post-processing control unit 281 of the finisher 107. At this point, the reading control unit 241 adds information of the delay time to the timing information when it is necessary.

Next, in S14, the reading control unit 241 waits for output of the sheet from the image-forming apparatus 101. While waiting for the output of the sheet, in a case where pre-adjustment of the sheet interval is performed, the reading control unit 241 receives again timing information from the print control unit 221 in S12, and forwards the timing information to the post-processing control unit 281 in S13. When the sheet (hereinafter, referred to as a target sheet) is accepted from the image-forming apparatus 101 by the inspection apparatus 103, the processing proceeds to S15.

In S15, the reading control unit 241 causes the reading unit 133 to execute the reading operation. The reading unit 133 optically reads the target sheet to generate a read image. The calibration unit 243 executes the shading correction on the read image in accordance with the correction coefficients indicated by the calibration data 246.

Next, in S16, the inspection unit 242 executes the image inspection based on the read image after the shading correction to determine whether the target sheet is a normal sheet or a defective sheet. The inspection unit 242 outputs a result of the image inspection to the job control unit 209.

Next, in S17, the reading control unit 241 determines whether or not the number of read sheets Cₛₕ reaches the upper limit number of sheets Cₘₐₓ. In a case where the number of read sheets Cₛₕ does not reach the upper limit number of sheets Cₘₐₓ, the processing proceeds to S18. Meanwhile, in a case where the number of read sheets Cₛₕ reaches the upper limit number of sheets Cₘₐₓ, the processing proceeds to S20.

In S18, the reading control unit 241 compares the sheet interval Iₛₕ notified for the target sheet with the second threshold Iₜₕ₂. In a case where the sheet interval Iₛₕ is shorter than the second threshold Iₜₕ₂, the measurement operation is not executed, and the processing proceeds to S26. Meanwhile, in a case where the sheet interval Iₛₕ is equal to or longer than the second threshold Iₜₕ₂, the processing proceeds to S19.

In S19, the reading control unit 241 determines whether the number of read sheets Cₛₕ has reached the lower limit number of sheets Cₘᵢₙ. In a case where the number of read sheets Cₛₕ has not reached the lower limit number of sheets Cₘᵢₙ, the measurement operation is not executed, and the processing proceeds to S26. Meanwhile, in a case where the number of read sheets Cₛₕ has reached the lower limit number of sheets Cₘᵢₙ, the processing proceeds to S20.

In S20, the reading control unit 241 compares the sheet interval Iₛₕ with the first threshold Iₜₕ₁ that is greater than the second threshold Iₜₕ₂. In a case where the sheet interval Iₛₕ is equal to or longer than the first threshold Iₜₕ₁, the first measurement mode is selected, and the processing proceeds to S21. In S21, the reading control unit 241 causes the reading unit 133 to start the preliminary light emission. The LED 302 of the reading unit 133 emits light at the second light amount level. Meanwhile, in a case where the sheet interval Iₛₕ is shorter than the first threshold Iₜₕ₁, the second measurement mode is selected, and the preliminary light emission in S21 is skipped. Then, the processing proceeds to S22.

In S22, the reading control unit 241 causes the reading unit 133 to stand by until the timing to start the measurement operation. Next, in S23, the reading control unit 241 causes the reading unit 133 to execute the measurement operation. The CIS unit 301 moves from the reading position P1 to the measurement position P2, and irradiates the reference white plate 304 with a light at the first light amount level to measure luminance of reflected light. In S24, the calibration unit 243 updates the calibration data 246 based on a result of the luminance measurement. The CIS unit 301 returns from the measurement position P2 to the reading position P1. Next, in S25, the reading control unit 241 resets the counter Cₛₕ to zero. Then, the processing proceeds to S27.

In a case where the processing proceeds to S26 without the measurement operation executed, the reading control unit 241 increments the counter Cₛₕ (adds 1 to it). Then, the processing proceeds to S27.

In S27, the reading control unit 241 determines whether a next sheet is output from the image-forming apparatus 101 or not. In a case where a next sheet is output, the processing goes back to S12, new timing information is received and forwarded, and the processing steps S14 to S26 are repeated for the next sheet. In a case where no next sheet is output, the measurement control processing of FIG. 14 ends.

Thus far, several embodiments and examples of the technology according to the present disclosure have been described using FIGS. 1 to 14. In the above-described embodiments, an inspection apparatus which executes image inspection based on a read image of a sheet downstream of an image-forming apparatus receives time interval information indicating a time interval between a first sheet and a subsequent second sheet from the image-forming apparatus. The inspection apparatus selects a measurement mode of a measurement operation executed during an interval between a first reading operation for the first sheet and a second reading operation for the second sheet based on comparison between the time interval indicated by the time interval information and a first threshold. The measurement operation is an operation for measuring luminance of a reference member used for calibration of the reading operation. In a case where the time interval between the first and second sheets is equal to or longer than the first threshold, a first measurement mode is selected in which preliminary light emission of a light-emitting element is started before the measurement operation. According to the first measurement mode, the preliminary light emission results in a temperature rise so that the measurement operation for the calibration is executed in a state in which characteristics of the optical reading of sheets in the inspection apparatus are more stable. As such, it is possible to mitigate the impact of temperature change during job execution and to enhance image inspection accuracy. In a case where the time interval between the first and second sheets is shorter than the first threshold, a second measurement mode is selected in which the preliminary light emission of the light-emitting element is not performed before the measurement operation. In this manner, as the preliminary light emission is not performed before the measurement operation in a situation where there is no time margin between sheets, it is possible to maintain high productivity of print jobs.

### 10. Modification Examples

Various modification examples can be contemplated for the above-described embodiments. In a certain modification example, the inspection apparatus may determine whether the time interval between the first and second sheets matches a predetermined specific value instead of comparing the time interval indicated by the time interval information with the first threshold (and a second threshold). If required time of adjustment operations that can be executed by the image-forming apparatus in the middle of a print job is limited to some theoretical values in advance, a value of a sheet interval notified in pre-adjustment is also limited to some candidate values. Hence, determination on the value of the sheet interval can be substituted for the above-described threshold comparison. For example, in the scenarios described using FIGS. 13A to 13C, the following conditional branching of the measurement control can be conceived depending on a value of the sheet interval Iₛₕ:

```
  • If Iₛₕ = 4.7 seconds (first interval) then
  → the measurement operation is re-executed in the first measurement mode
(with preliminary light emission)
  • If Iₛₕ = 2.8 seconds (second interval) then
  → the measurement operation is re-executed in the second measurement mode
(without preliminary light emission)
  • If Iₛₕ = 0.3 seconds (third interval) then
  → the measurement operation is not re-executed
```

The specific values of the first, second, and third intervals indicated here are mere examples for explanation. There may exist multiple candidate values that are used for a condition to select each measurement mode.

In the above-described modification example, the time interval information or the timing information received from the image-forming apparatus by the inspection apparatus may not necessarily indicate the time interval between the first and second sheets as a numerical value. Alternatively, the image-forming apparatus may transmit, to the inspection apparatus, information that indicates a type of operation executed during an interval from forming an image on the first sheet to forming an image on the second sheet. The inspection apparatus can perform the measurement control depending on the type of operation indicated by the information from the image-forming apparatus, for example, as follows:

```
  • If the adjustment operation to be executed is positional misalignment correction
(first type) then
  → Iₛₕ = 4.7 seconds (first interval)
  → the measurement operation is re-executed in the first measurement mode
(with preliminary light emission)
  • If the adjustment operation to be executed is toner ejection (second type) then
  → Iₛₕ = 2.8 seconds (second interval)
  → the measurement operation is re-executed in the second measurement mode
(without preliminary light emission)
  • If no adjustment operation is executed then
  → Iₛₕ = 0.3 seconds (third interval)
  → the measurement operation is not re-executed
```

There may exist multiple types of operation used for a condition to select each measurement mode (for example, the first measurement mode is selected in a case where the adjustment operation to be executed is positional misalignment correction or color tone correction, and so on).

It is possible to mitigate the impact of temperature change during job execution to enhance the inspection accuracy according to the above-described modification examples, too.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-065205, filed Apr. 10, 2025, which is hereby incorporated by reference herein in its entirety.

What is claimed is:

1. An inspection apparatus comprising:
a conveyance unit configured to convey a sheet on which an image has been formed by an image-forming apparatus;
a reading unit configured to execute a reading operation to irradiate the sheet with light and read reflected light from the sheet;
an inspection unit configured to inspect the sheet based on a read image generated as a result of the reading operation;
a control unit configured to cause the reading unit to execute a measurement operation to irradiate a reference member with light and measure luminance of reflected light from the reference member during a time period when the reading unit does not perform the reading operation;
a calibration unit configured to generate calibration data to be used in calibrating the reading operation based on a result of the measurement operation; and
a communication unit configured to receive, from the image-forming apparatus, time interval information indicating a time interval between a first sheet and a second sheet conveyed next to the first sheet,
wherein the control unit is configured to be able to cause the reading unit to execute the measurement operation in a first measurement mode or a second measurement mode between a first reading operation for the first sheet and a second reading operation for the second sheet,
the reading unit is configured to cause a light-emitting element to start light emission before the measurement operation in the first measurement mode,
the reading unit is configured not to cause the light-emitting element to emit light before the measurement operation in the second measurement mode, and
the control unit is configured to
cause the reading unit to execute the measurement operation in the first measurement mode in a case where the time interval indicated by the time interval information is equal to or longer than a first threshold, and
cause the reading unit to execute the measurement operation in the second measurement mode in a case where the time interval indicated by the time interval information is shorter than the first threshold.

2. The inspection apparatus according to claim 1, wherein the reading unit is configured to, in the first measurement mode, cause the light-emitting element to start light emission at a second light amount level that is greater than a first light amount level set in the measurement operation.

3. The inspection apparatus according to claim 2, wherein a light amount of the light-emitting element is controlled through pulse width modulation, and
a light amount difference between the first light amount level and the second light amount level is based on a difference in a duty ratio in the pulse width modulation.

4. The inspection apparatus according to claim 3, wherein the duty ratio when the light-emitting element emits light at the second light amount level is 100%.

5. The inspection apparatus according to claim 2, wherein a light amount of the light-emitting element is controlled through adjustment of an amount of current, and
a light amount difference between the first light amount level and the second light amount level is based on a difference in an amount of current that flows through the light-emitting element.

6. The inspection apparatus according to claim 1, wherein the control unit is configured not to cause the reading unit to execute the measurement operation between the first reading operation and the second reading operation in a case where the time interval indicated by the time interval information is shorter than a second threshold that is shorter than the first threshold.

7. The inspection apparatus according to claim 6, wherein the control unit is configured to
count a number of read sheets representing a number of sheets for which the reading operation is performed after the reading unit previously executed the measurement operation, and
in a case where the number of read sheets does not reach a predetermined lower limit number of sheets, not cause the reading unit to execute the measurement operation between the first reading operation and the second reading operation regardless of the time interval indicated by the time interval information.

8. The inspection apparatus according to claim 7, wherein the control unit is configured to cause the reading unit to execute the measurement operation between the first reading operation and the second reading operation in a case where the number of read sheets reaches a predetermined upper limit number of sheets.

9. The inspection apparatus according to claim 8, wherein the communication unit is configured to receive the time interval information indicating the time interval between the first sheet and the second sheet prior to the second sheet being output from the image-forming apparatus, and
the control unit is configured to, in a case where the number of read sheets reaches the predetermined upper limit number of sheets at the second sheet and when the time interval indicated by the time interval information is shorter than the second threshold, delay output of the second sheet from the image-forming apparatus so that an interval between the first sheet and the second sheet will be at least equal to or longer than the second threshold.

10. The inspection apparatus according to claim 6, wherein the reading unit is configured to be able to move between a reading position to read reflected light from the sheet and a measurement position to measure luminance of reflected light from the reference member, and
the second threshold is longer than a required time for the reading unit to move back and forth between the reading position and the measurement position.

11. The inspection apparatus according to claim 1, wherein the calibration unit is configured to correct one or both of a light amount by which the reading unit irradiates the sheet and a read pixel value in the read image in accordance with the calibration data so as to mitigate an impact of non-uniformity of a light amount or sensitivity in the reading operation.

12. An image-forming system comprising:
an inspection apparatus; and
an image-forming apparatus,
wherein the inspection apparatus includes:
a conveyance unit configured to convey a sheet on which an image has been formed by the image-forming apparatus;
a reading unit configured to execute a reading operation to irradiate the sheet with light and read reflected light from the sheet;
an inspection unit configured to inspect the sheet based on a read image generated as a result of the reading operation;
a control unit configured to cause the reading unit to execute a measurement operation to irradiate a reference member with light and measure luminance of reflected light from the reference member during a time period when the reading unit does not perform the reading operation;
a calibration unit configured to generate calibration data to be used in calibrating the reading operation based on a result of the measurement operation; and
a communication unit configured to receive, from the image-forming apparatus, time interval information indicating a time interval between a first sheet and a second sheet conveyed next to the first sheet,
wherein the control unit is configured to be able to cause the reading unit to execute the measurement operation in a first measurement mode or a second measurement mode between a first reading operation for the first sheet and a second reading operation for the second sheet,
the reading unit is configured to cause a light-emitting element to start light emission before the measurement operation in the first measurement mode,
the reading unit is configured not to cause the light-emitting element to emit light before the measurement operation in the second measurement mode, and
the control unit is configured to
cause the reading unit to execute the measurement operation in the first measurement mode in a case where the time interval indicated by the time interval information is equal to or longer than a first threshold, and
cause the reading unit to execute the measurement operation in the second measurement mode in a case where the time interval indicated by the time interval information is shorter than the first threshold.

13. The image-forming system according to claim 12, wherein the image-forming apparatus includes:
an image-forming unit configured to form an image on a sheet and to execute an adjustment operation in the middle of a print job that spans over a plurality of sheets; and
a generation unit configured to generate the time interval information based on whether or not the adjustment operation is executed during a time period from forming an image on the first sheet to forming an image on the second sheet and a type of the executed adjustment operation,
wherein the control unit is configured to receive the time interval information generated by the generation unit through the communication unit.

14. The image-forming system according to claim 13, wherein the adjustment operation includes at least one of
ejecting unconsumed deteriorated toner,
correcting positional misalignment between images of different color components, and
correcting color tone of an image of at least one color component.

15. An inspection apparatus comprising:
a conveyance unit configured to convey a sheet on which an image has been formed by an image-forming apparatus;
a reading unit configured to execute a reading operation to irradiate the sheet with light and read reflected light from the sheet;
an inspection unit configured to inspect the sheet based on a read image generated as a result of the reading operation;
a control unit configured to cause the reading unit to execute a measurement operation to irradiate a reference member with light and measure luminance of reflected light from the reference member during a time period when the reading unit does not perform the reading operation;
a calibration unit configured to generate calibration data to be used in calibrating a light amount in the reading operation based on a result of the measurement operation; and
a communication unit configured to receive, from the image-forming apparatus, information related to a time interval between a first sheet and a second sheet conveyed next to the first sheet,
wherein the control unit is configured to be able to cause the reading unit to execute the measurement operation in a first measurement mode or a second measurement mode between a first reading operation for the first sheet and a second reading operation for the second sheet,
the reading unit is configured to cause a light-emitting element to start light emission before the measurement operation in the first measurement mode,
the reading unit is configured not to cause the light-emitting element to emit light before the measurement operation in the second measurement mode, and
the control unit is configured to
cause the reading unit to execute the measurement operation in the first measurement mode in a case where it is determined that the time interval is a first interval based on the information received by the communication unit, and
cause the reading unit to execute the measurement operation in the second measurement mode in a case where it is determined that the time interval is a second interval that is shorter than the first interval based on the information received by the communication unit.

16. The inspection apparatus according to claim 15, wherein the reading unit is configured to, in the first measurement mode, cause the light-emitting element to start light emission at a second light amount level that is greater than a first light amount level set in the measurement operation.

17. The inspection apparatus according to claim 15, wherein the control unit is configured not to cause the reading unit to execute the measurement operation between the first reading operation and the second reading operation in a case where it is determined that the time interval is a third interval that is shorter than the second interval based on the information received by the communication unit.

18. The inspection apparatus according to claim 15, wherein the information related to the time interval indicates a value of the time interval.

19. The inspection apparatus according to claim 15, wherein the information related to the time interval indicates a type of an operation executed by the image-forming apparatus during a time period from forming an image on the first sheet to forming an image on the second sheet.
